(19) United States
(12) Patent Application Publication
(10) Pub. No.: US 2017/0135316 A1
(43) Pub. Date: May 18, 2017

(54) Cat Scratcher Device and Method of Assembly

(71) Applicant: Worldwise, Inc., Novato, CA (US)

(72) Inventor: Mark Hartelius, Chicago, IL (US)

(21) Appl. No.: 14/939,737

(22) Filed: Nov. 12, 2015

(51) Int. Cl. A01K 15/02

(52) U.S. Cl. CPC A01K 15/024

(57) ABSTRACT

A cat scratcher device fabricated from a kit of parts as well as a method for its assembly The device includes a base and cylinder both having surfaces covered by cat scratching material. The cylinder has a first end and a second end, the first end abutting the base and the second end extending distally therefrom and an end cap sized to fit over the second end of the cylinder which is provided with a pawl centrally located therein. A ribbed cable strap is included in the kit, the first end of which is secured to the base and the second end of which passes through the pawl such that when the ribbed cable strap is pulled through the pawl, it is tensioned to secure the cylinder to the base.

### TECHNICAL FIELD

The present invention involves a cat scratching device for providing cat scratching surfaces of the type used by domestic cats. The device can be shipped and warehoused as a kit of individual parts and which is designed to be easily assembled by a pet owner.

### BACKGROUND OF THE INVENTION

It is well recognized that domestic cats crave scratching as part of their natural instinctive character If a dedicated scratching surface is not provided, domestic cats will generally satisfy their need to scratch by turning to furniture, curtains and other articles which may be substantially damaged as a consequence Often times, pet cats will not only climb over furniture, specially upholster chairs and sofas, but will use such furniture and carpeting to condition their claws through deliberate repeated clawing, pulling and tearing actions specifically with their forepaws. As noted, this clawing activity appears to be an irresistible natural impulse for cats and can be the source of great aggravation to the pet owner. As such, a dedicated scratcher is a necessity for any cat owner.

A number of vendors of pet and pet related products have offered dedicated scratching posts and surfaces in order to ameliorate this problem. Scratching posts are generally sold as fully assembled constructs thus obviating the need to assemble the scratcher from a kit of parts Vendors of such products generally opt to warehouse and sell assembled scratchers as many pet owners do not have ready access to the tools necessary for assembly

There are certainly drawbacks in shipping and promoting for sale fully assembled scratchers. Among them are shipping costs which represent a significant fraction of the products' overall price. It has become increasingly common to manufacture such products offshore where labor costs are less than those in this country. This is particularly true as it pertains to the manufacture of non-complex or relatively low end products which can be assembled by relatively unskilled labor However, as manufacturing has shifted offshore, shipping costs have become an increasingly more significant percentage of product pricing

Typically, manufactured goods produced in Asia are imported into the United States on commercial vessels. These goods are not only manufactured but packaged at Asian factories and multiple units placed within cardboard containers or otherwise bundled in groups for placement within cargo containers which are, in turn, stacked atop one another in appropriately configured vessels. The shipping cost per item is dictated by the number of such items which can be placed within said shipping containers as the cost per transoceanic passage substantially remains fixed

Certain items, such as televisions, stereos, computers and semiconductor chips can be conveniently stacked within rectangular shipping containers as such products are usually enclosed within square or rectangular boxes which optimally stack in such containers However, self-supporting scratchers, if shipped assembled, cannot be densely packed within transoceanic shipping containers and thus, the cost of shipping such products can be inordinately high In addition, once such products are received by a retailer, warehousing them can be a challenge as a fully assembled scratcher occupies more warehousing space than is justified by the price of the product. This also pertains to the inordinately excessive shelf space that such a product would occupy noting that inefficient shelving negatively impacts profitability

It is thus an object to the present invention to provide a scratcher device which can be shipped and warehoused in kit form.

It is yet a further object of the present invention to provide a scratcher device which can be purchased by a pet owner in kit form and easily assembled without the use of tools or by engaging in complex assembly steps.

These and further objects be more readily apparent when considering the following disclosure and appended claims

### SUMMARY OF THE INVENTION

A cat scratcher device comprising a base, said base having an outer surface substantially covered by a cat scratching material, a substantially cylindrical member also having an outer surface substantially covered by a cat scratching material, said substantially cylindrical member having a first end and a second end, said first end abutting said base and said second end extending distally therefrom, an end cap sized to fit over and substantially cover said second end of said substantially cylindrical member, said end cap having a pawl centrally located therein, a ribbed cable strap, a first end of which is secured to said base and a second end of which passes through said pawl such that when said ribbed cable strap is pulled through said pawl, said ribbed cable strap is tensioned to secure said substantially cylindrical member to said base

A cat scratcher device comprising a base, said base having an outer surface substantially covered by a cat scratching material, a substantially cylindrical member also having an outer surface substantially covered by a cat scratching material, said substantially cylindrical member having a first end and a second end, said first end abutting said base and said second end extending distally therefrom, an end cap sized to fit over and substantially cover said second end of said substantially cylindrical member, said end cap having an opening centrally located therein, a ribbed cable strap, a first end of which is secured to said base and a second end of which passes through said opening, a tether having a tether first end and a tether second end, said tether first end comprising a pawl such that when said ribbed cable strap is pulled through said pawl, said ribbed cable strap is tensioned to secure said substantially cylindrical member to said base

A method of assembling a cat scratcher device, said cat scratcher device comprising a base, said base having an outer surface substantially covered by a cat scratching material, a substantially cylindrical member also having an outer surface substantially covered by a cat scratching material, said substantially cylindrical member having a first end and a second end such that when assembled, said first end abuts said base and said second end extends distally therefrom, an end cap sized to fit over and substantially cover said second end of said substantially cylindrical member, said end cap having a pawl centrally located therein and a ribbed cable strap having a first end and a second end, said method comprising affixing the first end of the ribbed cable strap to said base and pulling the second end of the ribbed cable strap through said substantially cylindrical member, placing said end cap over said second end of said substantially cylindrical member, positioning said first end of said substantially cylindrical member onto said base, passing the second end of said ribbed cable strap through said pawl to tension said ribbed cable strap and to secure said substantially cylindrical member to said base.

A method of assembling a cat scratcher device, said cat scratcher device comprising a base, said base having an outer surface substantially covered by a cat scratching material, a substantially cylindrical member also having an outer surface substantially covered by a cat scratching material, said substantially cylindrical member having a first end and a second end such that when assembled, said first end abuts said base and said second end extends distally therefrom, an end cap sized to fit over and substantially cover said second end of said substantially cylindrical member, said end cap having an opening centrally located therein, a tether having a tether first end and a tether second end, said tether first end comprising a pawl and a ribbed cable strap having a first end and a second end, said method comprising affixing the first end of the ribbed cable strap to said base and pulling the second end of the ribbed cable strap through said substantially cylindrical member, placing said end cap over said second end of said substantially cylindrical member, positioning said first end of said substantially cylindrical member onto said base, passing the second end of said ribbed cable strap through said opening in said end cap and through said pawl in said tether first end to tension said ribbed cable strap and to secure said substantially cylindrical member to said base.

### BRIEF DESCRIPTION OF THE DRAWINGS

FIGS. 1A & 1B are perspective views of two iterations of the present invention.

FIGS. 2A & 2B are perspective views of a base suitable for use in producing the invention as depicted in FIGS. 1A & 1B

FIGS. 2C & 2D illustrate the steps involved in constructing the embodiment of the present invention as shown in FIG. 1B

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto Those skilled in the art will appreciate that the conception upon which this disclosure is based readily may be utilized as a basis for the designing of other structures, methods and systems for carrying out the several purposes of the present invention It is important therefore, that claims be regarded as including such equivalent constructions insofar as they do not depart from the spirit and scope of the present invention

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof Reference in the singular tense include the plural and vice versa, unless otherwise noted.

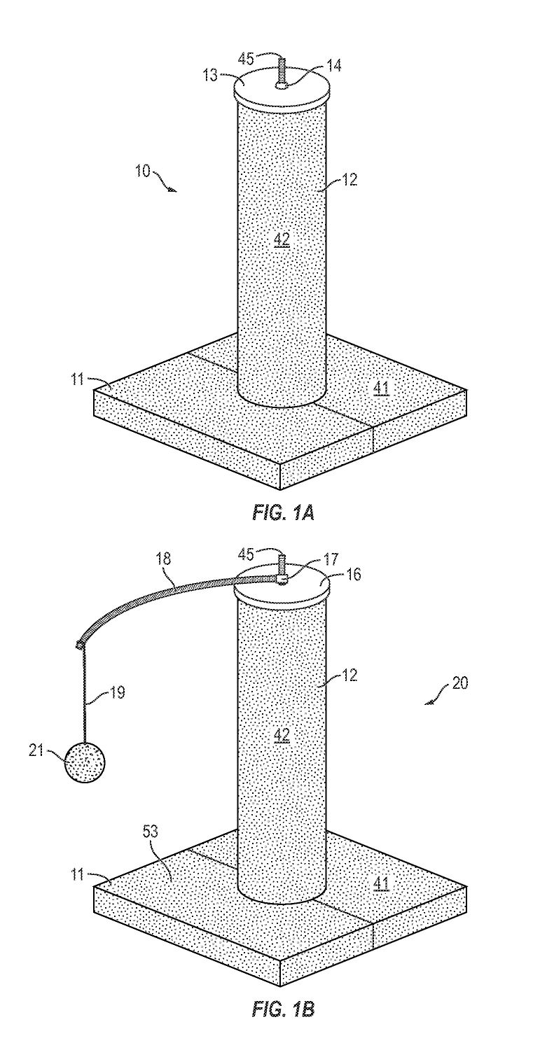

Turning to FIG. 1A, a first iteration of the present invention is depicted.. Cat scratcher device 10 is provided with base 11 having an outer surface substantially covered by cat scratching material 41 The device also includes substantially cylindrical member 12 also having an outer surface substantially covered by cat scratching material 42 The cat scratching material can be one of any variety of well-known materials employed for this purpose such as carpet, sisal and the like.

Substantially cylindrical member 12 is characterized as having a first end 4.3 and a second end 44, first end 43 abutting base 11 and second end 44 extending distally there from An end cap 13 is sized to fit over and substantially cover second end 44 of substantially cylindrical member 12, end cap 13 having pawl 14 centrally located therein

A ribbed cable strap 15 is provided having a first end 28 which is secured to base 11 and a second end 45 which passes through substantially cylindrical member 12 and end cap 13 by pulling end 45 through pawl 14. Because of the nature of ribbed cable strap 15 and pawl 14, once cable strap 15 is pulled through pawl 14 by grasping end 45, ribbed cable strap 15 is tensioned to secure substantially cylindrical member 12 to base 11 In doing so, fully assembled cat scratcher device 10 is fabricated from a kit of parts, namely, base 11, substantially cylindrical member 12, end cap 13 and ribbed cable strap 15 without the need for any tools whatsoever

A second embodiment of the cat scratcher device is depicted in FIG. 1B. As in the case of the embodiment of FIG. 1A, the second embodiment of the present invention includes base 11 having an outer surface substantially covered by cat scratching material 41 and substantially cylindrical member 12 also having an outer surface substantially covered by cat scratching material 42 The substantially cylindrical member is characterized as having first end 43 and second end 44, first end 43 abutting base 11 and second end 44 extending distally therefrom End cap 16 is sized to fit over and substantially cover second end 44 of substantially cylindrical member 12, end cap 16 having an opening 17 being centrally located therein. As with the embodiment of FIG. 1A, cat scratcher device 20 includes ribbed cable strap 15, first end 28 of which is secured to base 11 and second end 45 of which passes through opening 17 of end cap 16 However, unlike the embodiment of FIG. 1A, centrally located within end cap 16 is a mere opening and not a pawl.

In turning again to the embodiment of FIG. 1B, cat scratcher device 20 includes tether 18 having tether first end 47 comprising pawl 27 and at tether end 48 is line 19 which is used to append attractant 21 to tether 18. Pawl 27 receives end 45 of ribbed cable strap 15 for securing substantially cylindrical member 12 to base 11.

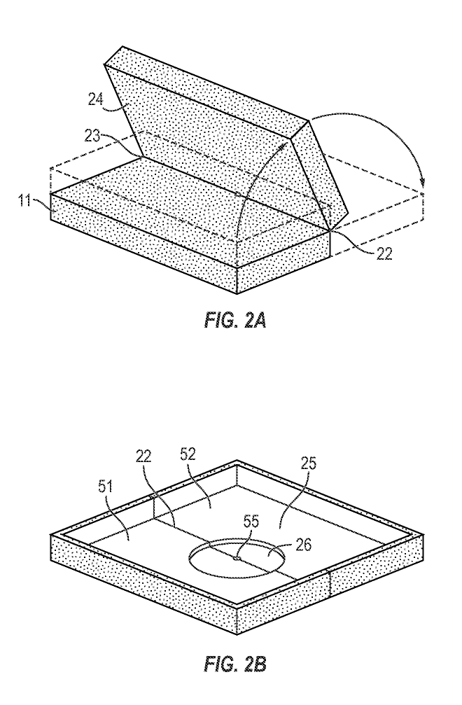

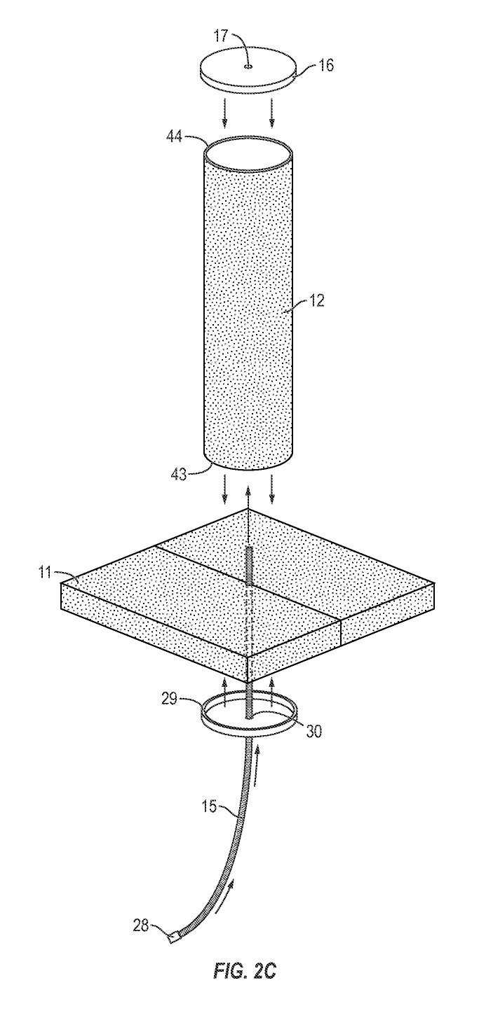

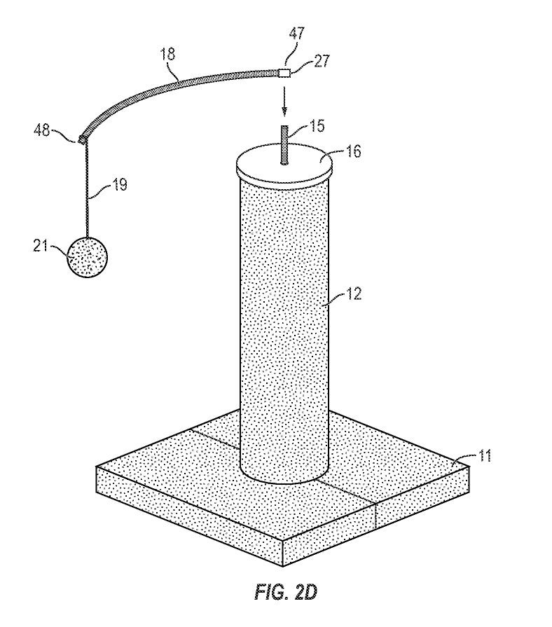

In order to provide a kit of parts which compacts most ideally, reference is made to FIGS. 2A and 2B Specifically, base 11 comprises first and second base halves 51 and 52 which can be made to fold onto each other by rotating the base halves along bisecting line 22 Cat scratching material 41 which is shown to cover base 11 acts as a living hinge 23 there between enabling base 11 to fold when being shipped or stored and to open to provide a substantially planar surface 53 to which substantially cylindrical member 12 is affixed. As a preferred embodiment, base 11 also includes indented region 26, the purpose of which will be discussed hereinafter.

In referring to FIGS. 2C and 2D, the steps of fabricating cat scratcher device 20 are illustrated noting that the same basic fabrication method could be applied to the embodiment of FIG. 1A by including pawl 14 within end cap 13 rather than employing pawl 27 made part of tether 18, employed for the same purpose in securing ribbed cable strap 15 to tension substantially cylindrical member 12 to base 11

The present method of assembly includes a kit of parts as noted previously If base 11 is folded (FIG. 2A), it is first rotated along living hinge 23 creating planar surface 53 Ribbed cable strap 15 is either applied directly through opening 55 of base 11 or, second end cap 29, sized to fit within indented portion 26 is applied to the underside of base 11 having an opening 30 sized to enable ribbed cable strap 15 to pass but not first end 28 thereof Thereupon, end cap 16 is applied to second end 44 of substantially cylindrical member 12 and first end 45 of ribbed cable strap 15 passed through opening 17 of end cap 16. Pawl 27 at end 47 of tether 18 is then drawn tightly over ribbed cable strap 15 to tension ribbed cable strap 15 securing substantially cylindrical member 12 to base 11. In doing so, a completed cat scratcher device including a tether and attractant is fabricated, again, using no tools whatsoever.

In summary, the present invention is directed to a cat scratcher device composed of a kit of parts which, prior to assembly, can be made to fit compactly within a relatively small container for shipment and storage and yet the kit of parts can be assembled by any pet owner without tools and without any complex assembly steps.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described Various modifications, alternative constructions, changes and equivalents will readily occur to those skilled in the art and may be employed as suitable without departing from the true spirit and scope of the invention Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A cat scratcher device comprising a base, said base having an outer surface substantially covered by a cat scratching material, a substantially cylindrical member also having an outer surface substantially covered by a cat scratching material, said substantially cylindrical member having a first end and a second end, said first end abutting said base and said second end extending distally therefrom, an end cap sized to fit over and substantially cover said second end of said substantially cylindrical member, said end cap having a pawl centrally located therein, a ribbed cable strap, a first end of which is secured to said base and a second end of which passes through said pawl such that when said ribbed cable strap is pulled through said pawl, said ribbed cable strap is tensioned to secure said substantially cylindrical member to said base.

2. The cat scratcher device of claim 1 further comprising a base cap centrally located within said base and secured to the first end of said ribbed cable strap

3. The cat scratcher device of claim 2 wherein said base comprises an indented region sized to receive said base cap when said base cap is secured to the first end of said ribbed cable strap

4. The cat scratcher device of claim 1 wherein said base comprises first and second base halves, said first and second base halves being foldable with respect to one another, said covering of said cat scratching material comprising a living hinge there between.

5. A cat scratcher device comprising a base, said base having an outer surface substantially covered by a cat scratching material, a substantially cylindrical member also having an outer surface substantially covered by a cat scratching material, said substantially cylindrical member having a first end and a second end, said first end abutting said base and said second end extending distally therefrom, an end cap sized to fit over and substantially cover said second end of said substantially cylindrical member, said end cap having an opening centrally located therein, a ribbed cable strap, a first end of which is secured to said base and a second end of which passes through said opening, a tether having a tether first end and a tether second end, said tether first end comprising a pawl such that when said ribbed cable strap is pulled through said pawl, said ribbed cable strap is tensioned to secure said substantially cylindrical member to said base.

6. The cat scratcher device of claim 5 further comprising and attractant toy affixed to said tether second end

7. The cat scratcher device of claim 5 further comprising a base cap centrally located within said base and secured to the first end of said ribbed cable strap.

8. The cat scratcher device of claim 7 wherein said base comprises an indented region sized to receive said base cap when said base cap is secured to the first end of said ribbed cable strap.

9. The cat scratcher device of claim 5 wherein said base comprises first and second base halves, said first and second base halves being foldable with respect to one another, said covering of said cat scratching material comprising a living hinge there between.

10. A method of assembling a cat scratcher device, said cat scratcher device comprising a base, said base having an outer surface substantially covered by a cat scratching material, a substantially cylindrical member also having an outer surface substantially covered by a cat scratching material, said substantially cylindrical member having a first end and a second end such that when assembled, said first end abuts said base and said second end extends distally therefrom, an end cap sized to fit over and substantially cover said second end of said substantially cylindrical member, said end cap having a pawl centrally located therein and a ribbed cable strap having a first end and a second end, said method comprising affixing the first end of the ribbed cable strap to said base and pulling the second end of the ribbed cable strap through said substantially cylindrical member, placing said end cap over said second end of said substantially cylindrical member, positioning said first end of said substantially cylindrical member onto said base, passing the second end of said ribbed cable strap through said pawl to tension said ribbed cable strap and to secure said substantially cylindrical member to said base

11. The method of claim 10 wherein said cat scratcher device further comprises a base cap, said method comprising positioning said base cap centrally within said base, the first end of said ribbed cable strap being a fixed to said base cap.

12. The method of claim 11 wherein said base further comprises an indented region, said method comprising applying said base cap to said indented region as the second end of said ribbed cable strap is pulled through said substantially cylindrical member

13. The method of claim 10 wherein said base comprises first and second base halves folded onto each other, said method further comprising unfolding said base halves, said cat scratching material acting as a living hinge there between forming a base having a substantially planar surface to which said substantially cylindrical member is affixed.

14. A method of assembling a cat scratcher device, said cat scratcher device comprising a base, said base having an outer surface substantially covered by a cat scratching material, a substantially cylindrical member also having an outer surface substantially covered by a cat scratching material, said substantially cylindrical member having a first end and a second end such that when assembled, said first end abuts said base and said second end extends distally therefrom, an end cap sized to fit over and substantially cover said second end of said substantially cylindrical member, said end cap having an opening centrally located therein, a tether having a tether first end and a tether second end, said tether first end comprising a pawl and a ribbed cable strap having a first end and a second end, said method comprising affixing the first end of the ribbed cable strap to said base and pulling the second end of the ribbed cable strap through said substantially cylindrical member, placing said end cap over said second end of said substantially cylindrical member, positioning said first end of said substantially cylindrical member onto said base, passing the second end of said ribbed cable strap through said opening in said end cap and through said pawl in said tether first end to tension said ribbed cable strap and to secure said substantially cylindrical member to said base.

15. The method of claim 14 wherein said cat scratcher device further comprises a base cap, said method comprising positioning said base cap centrally within said base, the first end of said ribbed cable strap being a fixed to said base cap

16. The method of claim 15 wherein said base further comprises an indented region, said method comprising applying said base cap to said indented region as the second end of said ribbed cable strap is pulled through said substantially cylindrical member.

17. The method of claim 14 wherein said base comprises first and second base halves folded onto each other, said method further comprising unfolding said base halves, said cat scratching material acting as a living hinge there between forming a base having a substantially planar surface to which said substantially cylindrical member is affixed.
